(19) United States
(12) Patent Application Publication
(10) Pub. No.: US 2013/0038801 A1
(43) Pub. Date: Feb. 14, 2013

(54) WIRELESS COMMUNICATION APPARATUS AND WIRELESS COMMUNICATION METHOD

(71) Applicant: KABUSHIKI KAISHA TOSHIBA, Tokyo (JP)

(72) Inventor: Satoshi Takezaki, Ome-shi (JP)

(73) Assignee: KABUSHIKI KAISHA TOSHIBA, Tokyo (JP)

(21) Appl. No.: 13/654,782

(22) Filed: Oct. 18, 2012

Related U.S. Application Data
(63) Continuation of application No. 12/949,496, filed on Nov. 18, 2010.

(30) Foreign Application Priority Data
Nov. 19, 2009 (JP) 2009-264228

(51) Int. Cl. H04N 5/63

(52) U.S. Cl. 348/734; 348/E05.127

(57) ABSTRACT

According to one embodiment, a wireless communication apparatus includes an interface module, a first wireless communication module, a second wireless communication module, and a power controller. The interface module configured to exchange content data and device control data with a first device. The first wireless communication module configured to wirelessly exchange the content data with a second device with consuming first power. The second wireless communication module configured to wirelessly exchange the device control data with the second device with consuming second power which is lower than the first power. The power controller configured to turn off power of the first wireless communication module when the first device does not exchange the content data.

### CROSS-REFERENCE TO RELATED APPLICATIONS

This application is a continuation of U.S. patent application Ser. No. 12/949,496, filed on Nov. 18, 2010, which is based upon and claims the benefit of priority from Japanese Patent Application No. 2009-264228, filed Nov. 19, 2009; the entire contents of which are incorporated herein by reference.

### FIELD

Embodiments described herein relate generally to a wireless communication apparatus and a wireless communication method for executing wireless data communication between a sink device and a source device.

### BACKGROUND

HDMI (High-Definition Multimedia Interface), for instance, is used as a standard of an interface for transmitting video data. The HDMI interface is used in order to transmit content data, such as a digital television signal, from various source devices, such as a personal computer, a DVD (Digital Versatile Disc) player and a set-top box, to various sink devices, such as a TV and a projector. The source device and the sink device are connected over a single cable. Content data (video data, audio data), which is output from the source device, is transmitted to the sink device via the single cable.

Furthermore, in recent years, WirelessHD is used as an interface standard for transmitting content data by wireless communication. The WirelessHD can transmit high-image-quality content in a non-compressed state, without requiring cable connection between devices. In the WirelessHD, data transmission is performed with use of millimeter waves in a 60 GHz band. Specifically, since high-frequency electromagnetic waves are often transmitted in the wireless communication by WirelessHD, the power consumption is high.

Jpn. Pat. Appin. KOKAI Publication No. 2007-306201 discloses an information terminal apparatus which is provided with a plurality of wireless communication modules, thereby achieving power saving. This information terminal apparatus (terminal) includes a first wireless communication module which can perform wireless communication with low power consumption, and a second wireless communication module which performs data communication by wireless LAN. In an ad-hoc mode in which beacon signals are periodically transmitted in order to indicate the presence of terminals when data communication is executed between the terminals, the second wireless communication module is, in principle, set in a sleep state. When actual data communication is executed, an activation signal is sent to a counterpart terminal by using the first wireless communication module, and the second wireless communication module is activated. If the data communication is completed, a stop signal is sent to the counterpart terminal by using the first wireless communication module, and the second wireless communication module of the transmission side is halted. Thus, the transmission of the beacon signal by the second wireless communication module is suppressed, and the power saving is achieved.

### SUMMARY OF CERTAIN INVENTIVE ASPECTS

As described above, the information terminal apparatus (terminal) includes the first wireless communication module which can perform wireless communication with low power consumption, and the second wireless communication module which performs the data communication, and one of the first wireless communication module and second wireless communication module is selectively used, thereby achieving power saving. In the above-described information terminal apparatus (terminal), however, the activation signal for activating the second wireless communication module and the stop signal for halting the second wireless communication module are exchanged with the counterpart terminal by using the first wireless communication module. In other words, transmission/reception of a special control signal is useful in order to selectively use the first wireless communication module and second wireless communication module.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 shows an example of a system configuration in which a source device and a sink device are connected in an embodiment;

FIG. 2 shows an example of a system configuration in which a source device and a sink device are connected by wireless communication in a first embodiment;

FIG. 3 is an exemplary block diagram showing the structure of a wireless communication apparatus in the first embodiment;

FIG. 4 is an exemplary flow chart illustrating the operation of the wireless communication apparatus in the first embodiment;

FIG. 5 shows an example of paths of power supply and data communication at a time when the source device in the first embodiment is in a data-communication-enabled state;

FIG. 6 shows an example of paths of power supply and data communication at a time of an operation state in which the source device in the first embodiment is in a powered-off operation state;

FIG. 7 is an exemplary block diagram which schematically shows the structure of a personal computer in which a wireless communication module according to a second embodiment is mounted; and

FIG. 8 is an exemplary block diagram showing a detailed structure of the personal computer in which the wireless communication module according to the second embodiment is mounted.

### DETAILED DESCRIPTION

Various embodiments will be described hereinafter with reference to the accompanying drawings.

In general, according to one embodiment, a wireless communication apparatus includes an interface module, a first wireless communication module, a second wireless communication module, and a power controller. The interface module configured to exchange content data and device control data with a first device. The first wireless communication module configured to wirelessly exchange the content data with a second device with consuming first power. The second wireless communication module configured to wirelessly exchange the device control data with the second device with consuming second power which is lower than the first power. The power controller configured to turn off power of the first wireless communication module when the first device does not exchange the content data.

Embodiments will now be described with reference to the accompanying drawings.

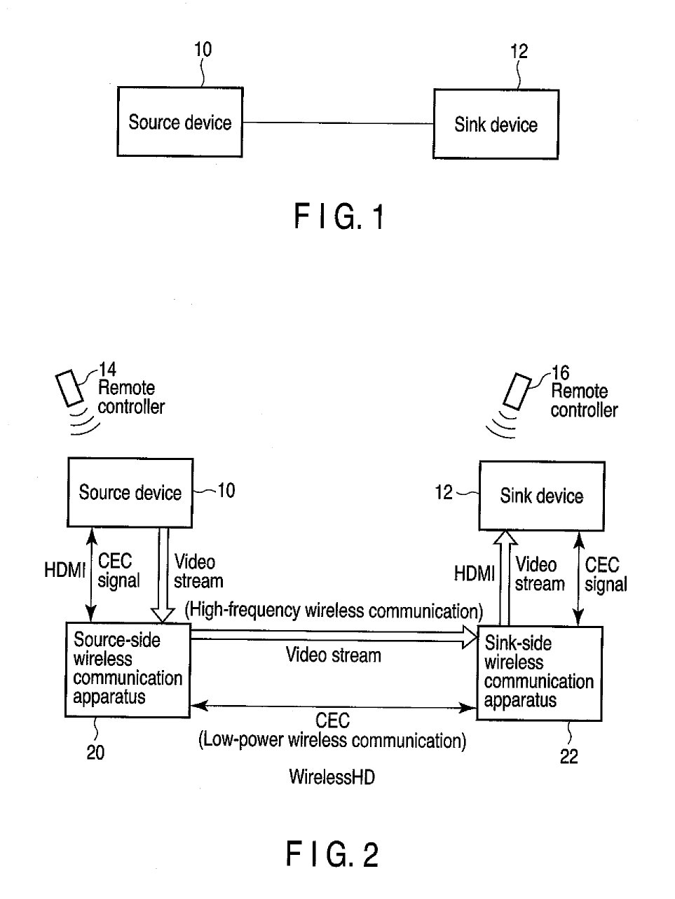

To begin with, a description is given of an ordinary system configuration example in which a source device 10, which transmits content data, and a sink device 12, which receives the content data and outputs content, are directly connected via a cable. If a TV and a DVD player are connected by a cable such as an HDMI cable, high-quality video can be enjoyed. In FIG. 1, an HDMI port of the source device 10 and an HDMI port of the sink device 12 are connected via a cable (HDMI cable).

The sink device 12 is a reception device having one or more HDMI input ports. For example, as the sink device 12, use may be made of a device which can reproduce and output content, such as a TV or a projector. The source device 10 is a transmission device having an HDMI output port, and a video output device of various kinds, such as a DVD player or a personal computer, can be used as the source device 10.

The source device 10 reads out data, which is called EDID (Enhanced Extended Display Identification Data), from the sink device 12 via a cable, thereby being able to determine the capability of the sink device 12. The EDID is identification information which is indicative of the capability of the sink device 12. The EDID includes a physical address which is to be allocated to a device which is connected to an HDMI input port of the sink device 12. The source device 10 acquires this physical address, thereby being able to construct an HDMI network which is composed of devices to which physical addresses are allocated.

### First Embodiment

FIG. 2 shows an example of a system configuration according to a first embodiment, in which the source device 10 and sink device 12 are connected via wireless communication by wireless communication apparatuses 20 and 22.

In FIG. 2, an HDMI cable is connected between an HDMI output port of the source device 10 and an HDMI input port of the source-side wireless communication apparatus 20. In addition, an HDMI cable is connected between an HDMI input port of the sink device 12 and an HDMI output port of the sink-side wireless communication apparatus 22.

Signals, which are specified by the HDMI standard, are transmitted/received via the HDMI cable between the source device 10 and source-side wireless communication apparatus 20. These signals include a signal indicative the operation state (source ready) of the source device 10, and a signal for EDID read-out, as well as content data (e.g. a video stream including video data and audio data).

A CEC signal according to a CEC (Consumer Electronics Control) standard, which is supported as an option of the HDMI standard, is transmitted/received via the HDMI cable between the source device 10 and source-side wireless communication apparatus 20. The CEC signal is indicative of device control data for mutual control between devices. For example, a remote controller 16 of a TV, which is, for example, the sink device 12, is operated by a command which is transmitted/received by the CEC signal. Thereby, a personal computer, which is the source device 10, can be controlled.

Similarly, signals, which are stipulated by the HDMI standard, are transmitted/received via the HDMI cable between the sink device 12 and the sink-side wireless communication device 22. These signals include a signal indicative the operation state (sink ready) of the sink device 12, and a signal for EDID read-out, as well as content data (e.g. a video stream including video data and audio data). In addition, a CEC signal is transmitted/received via the HDMI cable between the sink device 12 and sink-side wireless communication apparatus 22.

Each of the source-side wireless communication apparatus 20 and sink-side wireless communication apparatus 22 has a function of converting a wired signal, which is received via the HDMI cable, to a wireless signal and sending the wireless signal, and a function of converting a wireless signal, which is received by wireless communication, to a wired signal and sending the wired signal.

In addition, each of the source-side wireless communication apparatus 20 and sink-side wireless communication apparatus 22 includes a high-frequency wireless module 42 (to be described later) which executes high-frequency wireless communication according to the WirelessHD standard, and a low-power wireless module 44 (to be described later) which executes wireless communication with a lower power consumption than the high-frequency wireless module 42. Each of the source-side wireless communication apparatus 20 and sink-side wireless communication apparatus 22 transmits/receives content data including a video stream via high-frequency wireless communication by the high-frequency wireless module 42.

In the case where the source device 10 and sink device 12 are in a data-communication-enabled state, that is, in the case where the source device 10 and sink device 12 are powered on and are in operation, the source device 10 and sink device 12 transmit/receive CEC signals, together with video streams (content data), via high-frequency wireless communication by the high-frequency wireless module 42.

In the case where the source device 10 and sink device 12 are in a data-communication-disabled state, that is, in the case where the source device 10 and sink device 12 are powered off and are in a standby state or in a hibernate state, the source device 10 and sink device 12 transmit/receive CEC signals via low-power wireless communication by operating only the low-power wireless module 44.

The source-side wireless communication apparatus 20 receives content data and other various control data which are sent from the source device 10, and directly transfers the received content data and control data to the sink-side wireless communication device 22. The sink-side wireless communication device 22 receives the content data and other various control data which are sent from the source-side wireless communication apparatus 20, and directly transfers the received content data and control data to the sink device 12.

The sink-side wireless communication apparatus 22 receives various control data which are received from the sink device 12, and directly transfers the received control data to the source-side wireless communication device 20. Similarly, the source-side wireless communication device 20 receives the control data which are transferred from the sink-side wireless communication apparatus 22, and directly transfers the received data to the source device 10.

The CEC signals are signals for mutual control between the source device 10 and sink device 12. Functions (hereinafter referred to as “CEC functions”), which are realized by transmission/reception of CEC signals, include a one-touch play function, a pass-through function and a standby function.

In the one-touch play function, for example, if a DVD (Digital Versatile Disc) is played back in the source device 10 (e.g. a personal computer), the sink device 12 (AV device such as a TV), which is in a power-off state, is automatically powered on (wakeup), thereby effecting input switching so as to receive a signal from the source device 10.

In the first embodiment, in order to realize the one-touch play function, the low-power wireless modules 44 of the source-side wireless communication apparatus 20 and sink-side wireless communication apparatus 22 are set in the operable state so as to be able to transmit/receive the CEC signal, even in the state in which the source device 10 or sink device 12 is powered off and data communication is not executed. In addition, the communication path for transmitting/receiving the CEC signal is switched from the high-frequency wireless module 42 side to the low-power wireless module 44 side, thereby stopping the operation of the high-frequency wireless module 42 which consumes high power, and achieving power saving.

In the pass-through function, by operating the remote controller 16 for the sink device 12, a remote-control code from the remote controller 16 is transmitted to the source device 10, thus being able to execute control for the source device 10, such as menu display, playback and stop.

In addition, in the system standby function, a power-off instruction is issued to either the source device 10 or the sink device 12, thereby being able to powering off (shutting down) both the source device 10 and sink device 12 at a time.

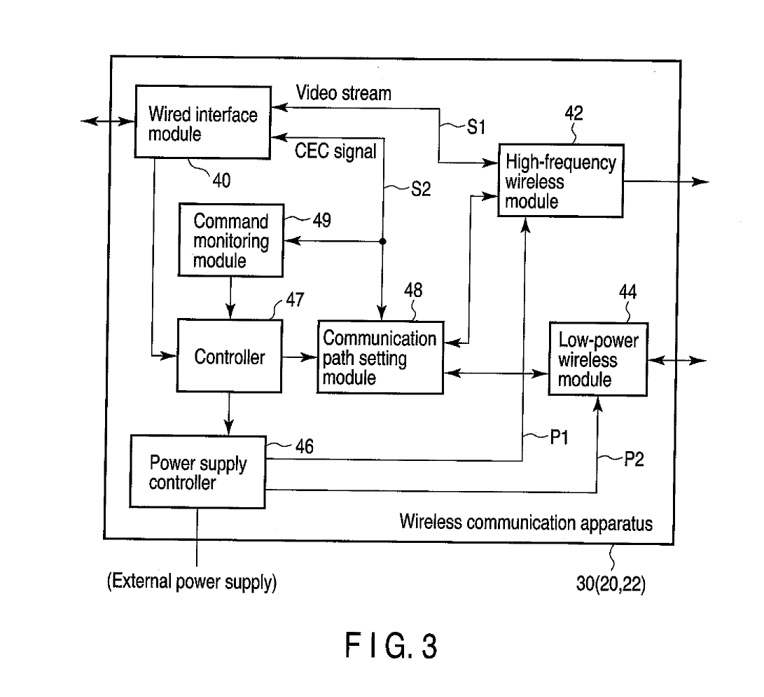

FIG. 3 is a block diagram showing the structure of a wireless communication apparatus 30 in the first embodiment.

The wireless communication apparatus 30 shown in FIG. 3 corresponds to the source-side wireless communication apparatus 20 and sink-side wireless communication apparatus 22 shown in FIG. 2. The description below is given of the source-side wireless communication apparatus 20.

The wireless communication apparatus 30 (source-side wireless communication apparatus 20) includes a wired interface module 40, a high-frequency wireless module 42, a low-power wireless module 44, a power supply controller 46, a controller 47, a communication path setting module 48 and a command monitoring module 49.

The wired interface module 40 executes communication with the source device 10 via an HDMI cable. The wired interface module 40 sends content data (video stream) and control data, which are received via the HDMI cable, to the high-frequency wireless module 42. In addition, the wired interface module 40 sends/receives a CEC signal for mutual control between the devices to/from the high-frequency wireless module 42 or the low-power wireless module 44 via the communication path setting module 48.

The high-frequency wireless module 42 executes high-frequency wireless communication according to, e.g. the WirelessHD standard. The high-frequency wireless module 42 is used in order to transmit content data (video stream) (S1). The power consumption at a time of data communication is high in the high-frequency wireless module 42 since the high-frequency wireless module 42 emits electromagnetic waves of high frequencies (e.g. 60 GHz band). When the source device 10 is in operation and is in a data-communication-enabled state, power supply (P1) is turned on from the power supply controller 46 to the high-frequency wireless module 42.

The low-power wireless module 44 executes wireless communication with a lower power consumption than the high-frequency wireless module 42. The low-power wireless module 44 is realized by, for example, an infrared communication module or a wireless LAN (Local Area Network) (WiFi) module. The low-power wireless module 44 is used in order to transmit/receive a CEC signal (S2) when the source device 10 is in a power-off state. When the source device 10 is in the power-off state, power supply (P2) is turned on from the power supply controller 46 to the low-power wireless module 44. When the source device 10 is in operation and the CEC signal is transmitted/received by the high-frequency wireless module 42, power supply to the low-power wireless module 44 is turned off.

The power supply controller 46 controls power supply to the respective components of the wireless communication apparatus 30 (source-side wireless communication device 20). In accordance with the process of a command which is determined by the command monitoring module 49, the power supply controller 46 controls power supply to the high-frequency wireless module 42 and low-power wireless module 44. In the case where the source device 10 is in operation and is in the data-communication-enabled state, the power supply to the high-frequency wireless module 42 is turned on and the power supply to the low-power wireless module 44 is turned off. On the other hand, in the case where the source device 10 is powered off, the power supply to the high-frequency wireless module 42 is turned off and the power supply to the low-power wireless module 44 is turned on. Thereby, even while the source device 10 is powered off, the CEC signal can be received by operating only the low-power wireless module 44, and power-saving can be achieved by stopping the operation of the high-frequency wireless module 42 which consumes high power.

The controller 47 controls the power supply controller 46 and communication path setting module 48 in accordance with a specific command which is determined by the command monitoring module 49. Specifically, in the case of a command to stop (power off) the operation of the source device 10, for example, a system standby command, the controller 47 causes the power supply controller 46 to turn off power supply to the high-frequency wireless module 42, and to turn on power supply to the low-power wireless module 44. In addition, the controller 47 causes the communication path setting module 48 to switch the communication path of the CEC signal to the low-power wireless module 44 side, so that the CEC signal may be transmitted/received by the low-power wireless module 44. On the other hand, in the case of a command to operate (power on) the source device 10, for example, a wakeup command, the controller 47 causes the power supply controller 46 to turn on power supply to the high-frequency wireless module 42, and to turn off power supply to the low-power wireless module 44. In addition, the controller 47 causes the communication path setting module 48 to switch the communication path of the CEC signal to the high-frequency wireless module 42 side, so that the CEC signal, as well as content data (video stream), may be transmitted/received by the high-frequency wireless module 42.

The communication path setting module 48 sets the communication path of the CEC signal to the high-frequency wireless module 42 side or to the low-power wireless section 44, in accordance with a command which is determined by the command monitoring module 49.

The command monitoring module 49 monitors the command which is transmitted/received to/from the counterpart device of wireless communication, on the basis of the CEC signal. In the case where the command monitoring module 49 monitors the CEC signal which is transmitted/received between the wired interface module 40 and the high-frequency wireless module 42 or low-power wireless module 44 and determines that a command relating to execution/stop of data communication has been transmitted/received, the command monitoring module 49 informs the controller 47 of this fact. An example of the command relating to execution/stop of data communication is a command which controls power-on/off of the source device 10. Examples of the command relating to power-on/off include a system standby command which instructs stop (power off) of the operation of the source device 10, and a wakeup command which activates the source device 10 which is in a power-off state.

The above description is based on the assumption that the wireless communication apparatus 30 shown in FIG. 3 is the source-side wireless communication device 20. Assuming that the sink-side wireless communication apparatus 22 has the same structure, a description thereof is omitted here.

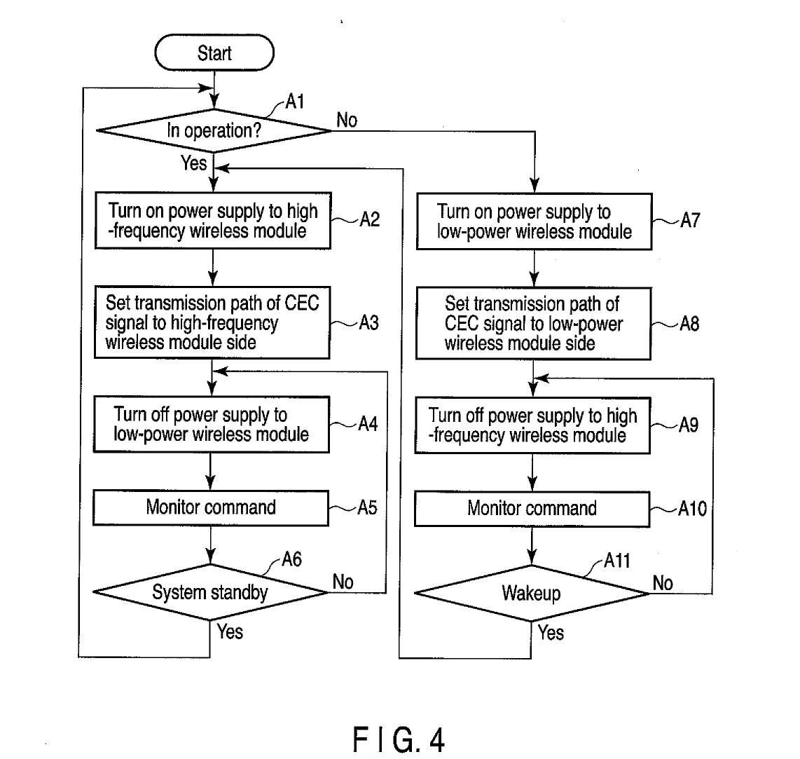

Next, referring to a flow chart of FIG. 4, a description is given of the operation of the wireless communication apparatus 30 in the first embodiment. In the description below, the source-side wireless communication apparatus 20, which is connected to the source device 10, is described.

The source device 10 is powered on, for example, by the operation of the remote controller 14. If the source device 10 is powered on, a source ready signal, which indicates that the source device 10 is in an operative state, is input to the controller 47 of the source-side wireless communication apparatus 20 via the wired interface module 40.

In the case where it is determined that the source device 10 is in the operative state (power-on) (Yes in block A1), the controller 47 instructs the power supply controller 46 to supply power to the high-frequency wiring module 42. In accordance with the instruction of the controller 47, the power supply controller 46 turns on power supply to the high-frequency wireless module 42 (block A2).

In addition, the controller 47 instructs the communication path setting module 48 to switch the communication path of the CEC signal to the high-frequency wireless module 42 side. The communication path setting module 48 sets the communication path in such a way that the CEC signal is transmitted between the wired interface module 40 and the high-frequency wireless module 42 (block A3).

Specifically, the source-side wireless communication apparatus 20 causes the high-frequency wireless module 42 to enable the wireless communication with the sink-side wireless communication apparatus 22 of the CEC signal together with the video stream (content data) and other control signals, which are input from the source device 10 via the wired interface module 40.

The controller 47 instructs the power supply controller 46 to stop power supply to the low-power wireless module 44. In accordance with an instruction from the controller 47, the power supply controller 46 turns off the power supply to the low-power wireless module 44 (block A4).

In the case where data communication by the source device 10 is enabled, wireless communication with the sink device 12 (sink-side wireless communication apparatus 22) is executed via only the high-frequency wireless module 42, and the operation of the low-power wireless module 44 is stopped. Thereby, power consumption by the low-power wireless module 44 is reduced.

While data communication is being executed between the source device 10 and sink device 12, for example, in the case where an instruction to control the device is output from the remote controller 14, 16, the CEC signal is transmitted/received between the source device 10 and the sink device 12 via the source-side wireless communication apparatus 20 and the sink-side wireless communication device 22.

While the wireless communication by the high-frequency wireless module 42 is being executed, the command monitoring module 49 monitors a command which is transmitted/received by the CEC signal between the source device 10 and the sink device 12 (block A5). The command monitoring module 49 determines, by the monitoring of the CEC signal, whether a command, which is received from the sink device 12, is a device control command which is associated with the stop of data communication by the source device 10. For example, a command of system standby for powering off the entire system is received, the source device 10 is powered off and the data communication is stopped. If the command monitoring module 49 has detected the reception of the system standby command (Yes in block A6), the command monitoring module 49 informs the controller 47 of this fact.

If the source device 10 receives the system standby command via the wired interface module 40, the source device 10 finishes the data communication and turns off power (standby state).

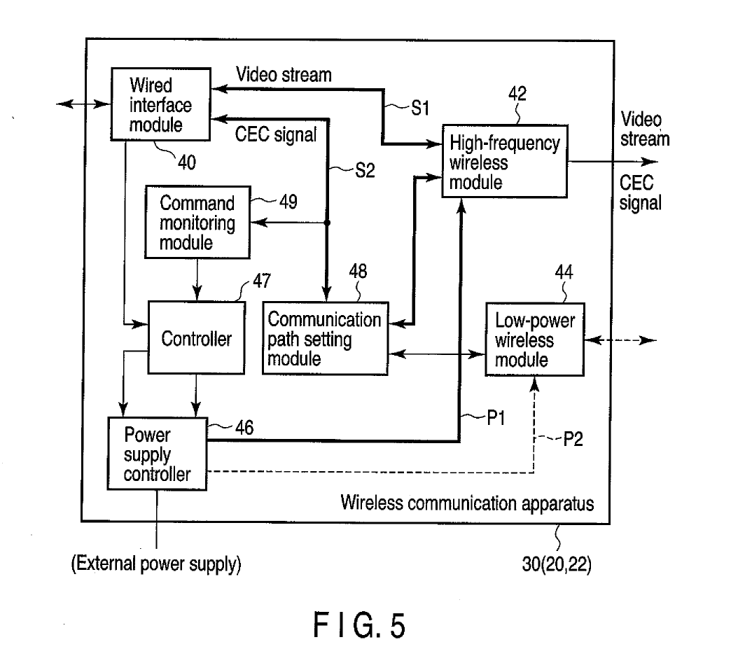

FIG. 5 shows the path of power supply and data communication at a time when the source device 10 is powered on and is in the data-communication-enabled state.

As shown in FIG. 5, when the source device 10 is powered on and is in a data-communication-enabled state, the power supply controller 46 turns on power supply P1 to the high-frequency wireless module 42 and renders the high-frequency wireless module 42 operable. In addition, the power supply controller 46 turns off power supply P2 to the low-power wireless module 44 so that no power may be consumed by the low-power wireless module 44.

Content data (video stream), which is transmitted from the source device 10, is sent from the wired interface module 40 to the high-frequency wireless module 42. Since the communication path setting module 48 effects switching to the communication path connecting the wired interface module 40 and high-frequency wireless module 42, the CEC signal is sent from the wired interface module 40 to the high-frequency wireless module 42. Accordingly, the high-frequency wireless module 42 transmits the CEC signal, together with the content data (video stream), to the sink-side wireless communication apparatus 22.

On the other hand, if the controller 47 is informed by the command monitoring module 49 that the data communication is to be stopped and the source device 10 is set in an operation halt (power-off) state, the controller 47 instructs the power supply controller 46 to supply power to the low-power wireless module 44. The power supply controller 46 turns on power supply to the low-power wireless module 44 in accordance with the instruction of the controller 47 (block A7).

In addition, the controller 47 instructs the communication path setting module 48 to switch the communication path of the CEC signal to the low-power wireless module 44 side. The communication path setting module 48 sets the communication path so that the CEC signal may be transmitted between the wired interface module 40 and the low-power wireless module 44 (block A8).

Specifically, the source-side wireless communication apparatus 20 enables wireless communication of the CEC signal with the sink-side wireless communication apparatus 22 via the low-power wireless module 44, even while data communication of content data (video stream) is not executed between the source device 10 and the sink device 12.

The controller 47 instructs the power supply controller 46 to stop power supply to the high-frequency wireless module 42. In accordance with an instruction from the controller 47, the power supply controller 46 turns off the power supply to the high-frequency wireless module 42 (block A9).

In this manner, in the state in which the source device 10 does not execute data communication, power supply to the high-frequency wireless module 42, which consumes high power, is turned off, and only the low-power wireless module 44, which consumes low power, is rendered operable, thereby reducing power consumption. When the source device 10 is in the power-off state (e.g. standby), the low-power wireless module 44 executes transmission/reception of the CEC signal with the sink device 12 via the sink-side wireless communication apparatus 22.

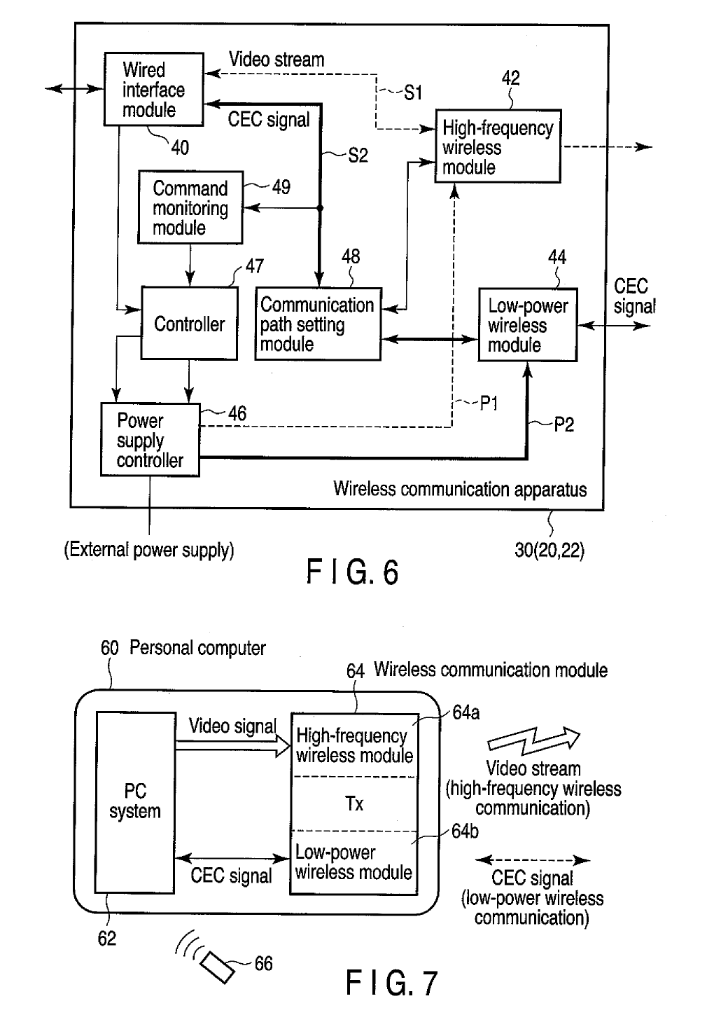

FIG. 6 shows the path of power supply and data communication at a time when the source device 10 is in a powered-off operation state (e.g. standby, hibernate).

As shown in FIG. 6, when the source device 10 is in a power-off state, the power supply controller 46 stops power supply to the high-frequency wireless module 42 and prevents the high-frequency wireless module 42 from consuming power. In addition, the power supply controller 46 supplies power to the low-power wireless module 44 so that the CEC signal may be transmitted/received with the sink device 12 (sink-side wireless communication apparatus 22).

Since the communication path setting module 48 effects switching to the communication path connecting the wired interface module 40 and low-power wireless module 44, the CEC signal is transmitted between the wired interface module 40 and the low-power wireless module 44. Accordingly, while the source device 10 is in the power-off state, the low-power wireless module 44 can transmit/receive the CEC signal to/from the sink-side wireless communication apparatus 22.

While the source device 10 is in the power-off state, the command monitoring module 49 monitors a command which is transmitted/received between the source device 10 and the sink device 12 (block A10). The command monitoring module 49 determines, by the monitoring of the CEC signal, whether a command, which is received from the sink device 12, is a control command for powering on the source device 10. For example, a wakeup command for powering on the source device 10 is received, the source device 10 is powered on and data communication is enabled. If the command monitoring module 49 has detected the reception of the wakeup command (Yes in block A11), the command monitoring module 49 informs the controller 47 of this fact.

The controller 47, as described above, instructs the power supply controller 46 to turn on power supply to the high-frequency wireless module 42, and to turn off power supply to the low-power wireless module 44. In addition, the controller 47 instructs the communication path setting module 48 to switch the communication path of the CEC signal to the high-frequency wireless module 42 side, thereby setting the communication path so that the CEC signal is transmitted between the wired interface module 40 and the high-frequency wireless module 42 (block A2 to block A4). Thereby, the CEC signal, together with the content data, can be transmitted by the high-frequency wireless module 42.

The above description has been given, by way of example, of the case where the source-side wireless communication apparatus 20 receives the command from the sink device 12 via the sink-side wireless communication apparatus 22. However, the power supply to the high-frequency wireless module 42 and low-power wireless module 44 can also be controlled in accordance with the command which is transmitted from the source device 10 to the sink device 12.

As has been described above, the wireless communication apparatus 30 (source-side wireless communication apparatus 20, sink-side wireless communication apparatus 22) in the first embodiment is provided with the high-frequency wireless module 42 and low-power wireless module 44. At the time of the normal operation, the content data (video stream) is transmitted/received by the high-frequency wireless module 42. In the state in which the source device 10 or sink device 12 is powered off, the power supply to the high-frequency wireless module 42 is turned off to achieve power saving, and the power supply to the low-power wireless module 44 is turned on so that the transmission/reception of the CEC signal (command) can be continued.

Although the above description is directed to the source-side wireless communication apparatus 20, the same control as for the source-side wireless communication apparatus 20 is also executed in the sink-side wireless communication apparatus 22. The sink-side wireless communication apparatus 22 can determine the operation state (power-on/off) of the sink device 12 in accordance with a signal indicative of a sink-ready state of the sink device 12, which is received via the wired interface module 40.

In the above description, in the state in which data communication is enabled (power-on) between the source device 10 and sink device 12, the CEC signal is transmitted/received via the high-frequency wireless module 42 between the source-side wireless communication apparatus 20 and the sink-side wireless communication apparatus 22. Alternatively, such a configuration may be adopted that the CEC signal is always transmitted/received by the low-power wireless module 44. In this case, the structure and control are needless for switching the transmission path of the CEC signal in accordance with the ON/OFF of power supply to the high-frequency wireless module 42.

The low-power wireless module 44 may directly pass the CEC signal through, or may convert the CEC signal to another command in accordance with the received CEC signal and may send it out.

In the above description, the wireless communication apparatus 30 (source-side wireless communication apparatus 20, sink-side wireless communication apparatus 22) is configured to be provided with the high-frequency wireless module 42 and low-power wireless module 44. Alternatively, the low-power wireless module 44 may be replaced with an external wireless communication device, such as a wireless LAN (WiFi) device, which can execute communication even in a standby state.

### Second Embodiment

FIG. 7 is a block diagram showing an example of a second embodiment.

In the structure of the first embodiment, the wireless communication apparatus 30 (source-side wireless communication apparatus 20, sink-side wireless communication apparatus 22) is configured as an apparatus which is independent from the source device 10 and sink device 12. Alternatively, the above-described function corresponding to the wireless communication apparatus 30 may be incorporated within the source device 10 and sink device 12.

FIG. 7 is a block diagram schematically showing the structure of a personal computer 60 in which a wireless communication module 64 corresponding to the wireless communication apparatus 30 is mounted. As shown in FIG. 7, content data (video signal) and CEC signals are transmitted/received between a PC system 62 (corresponding to the source device 10 or sink device 12 in the first embodiment) and the wireless communication module 64. The wireless communication module 64 includes a high-frequency wireless module 64a and a low-power wireless module 64b having the same functions as in the first embodiment.

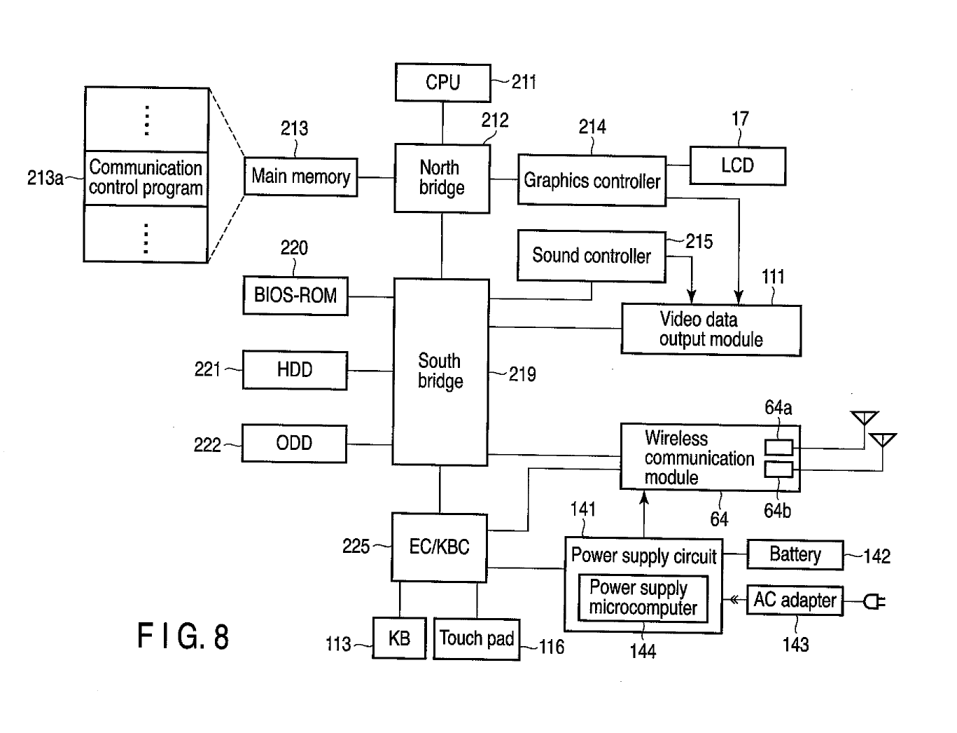

FIG. 8 is a block diagram showing a detailed structure of the personal computer 60 in which the wireless communication module 64 is mounted.

The personal computer 60 shown in FIG. 8 includes, in addition to a video data output module 111 and the wireless communication module 64, a CPU 211, a north bridge 212, a main memory 213, a graphic controller 214, a sound controller 215, a south bridge 219, a BIOS-ROM 220, a hard disk drive (HDD) 221, an optical disc drive (ODD) 222, and an embedded controller/keyboard controller IC (EC/KBC) 225.

The CPU 211 is a processor which controls the operation of the personal computer 60, and executes an operating system (OS) and various application/utility programs which are loaded from the hard disk drive (HDD) 221 into the main memory 213. The application/utility programs include a communication control program 213a. The communication control program 213a is a program for controlling the wireless communication module 64.

The CPU 221 also executes a BIOS (Basic Input/Output System) which is stored in the BIOS-ROM 220. The BIOS is a program for hardware control.

The north bridge 212 is a bridge device which connects a local bus of the CPU 211 and the south bridge 219. In addition, the north bridge 212 has a function of executing communication with the graphics controller 214.

The graphics controller 214 is a display controller which controls an LCD (Liquid Crystal Display) 17 which is used as a display monitor of the personal computer 60. A video signal, which is generated by the graphics controller 214, is sent to the LCD 17. In addition, the graphics controller 214 can deliver a digital video signal to the video data output module 111.

The south bridge 219 is a bridge device which controls various I/O devices. The video data output module 111 and wireless communication device 64 are connected to the south bridge 219. The embedded controller/keyboard controller IC (EC/KBC) 225 is a 1-chip microcomputer in which an embedded controller for power management and a keyboard controller for controlling a keyboard (KB) 113 and a touch pad 116 are integrated.

The video data output module 111 converts a video signal, which is output from the graphics controller 214, to transmission data of a predetermined format, and sends the transmission data to the wireless communication module 64. In the process of the conversion to the transmission data, it is possible to execute, where necessary, a process of compression-encoding the video signal which is output from the graphics controller 214. In addition, the video data output module 111 can also send an audio signal, which is output from the sound controller 215, to the wireless communication module 64 as transmission data.

A power supply circuit 141 generates, under the control of a power supply microcomputer 144, an operation power to the respective components by using power from a battery 142 which is attached to a computer main body, or power from an AC adapter 143 which is connected to the computer main body as an external power supply, and the power supply circuit 141 controls the power supply. At a time of a normal power-on state (or at a time of communication of content data by the wireless communication module 64), the power supply circuit 141 turns on power supply to the high-frequency wireless module 64a. At a time of power-off (standby, sleep, etc.), the power supply circuit 141 turns off the power supply to the high-frequency wireless module 64a.

The EC/KBC 225 has a function of powering on/off the personal computer 10 in accordance with the user's operation of a power button switch 14. The power-on/off control of the personal computer 10 is executed by the cooperation between the EC/KBC 225 and power supply circuit 141. At a time of power-off, if a command relating to power-on is received by the low-power wireless module 64b of the wireless communication module 64, the EC/KBC 225 turns on the power supply from the power supply circuit 141 to the high-frequency wireless module 64a.

As described above, even in the case of the structure in which the function corresponding to the wireless communication module 30 is incorporated in the source device 10 and sink device 12, the same advantageous effects as in the above-described first embodiment can be obtained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
an interface module configured to exchange content data and device control data with a first device, wherein the first device communicates with a second device for sending the content data;
a first wireless communication module configured to wirelessly exchange the content data and the device control data with the second device when the first device exchanges the content data, wherein a first path for the content data is defined between the first wireless communication module and the interface module, the first wireless communication module consuming a first power;
a second wireless communication module configured to wirelessly exchange the device control data with the second device when the first device does not exchange the content data, the second wireless communication module consuming a second power that is lower than the first power;
a setting module configured to set a second path for the device control data between the interface module and the first wireless communication module, and to cause the first wireless communication module to perform wireless communications for the device control data when the first device exchanges the content data, and the setting module being further configured to set a third path for the device control data between the interface module and the second wireless communication module and to cause the second wireless communication module to perform wireless communications for the device control data, when the first device does not exchange the content data; and
a power controller configured to turn off power to the first wireless communication module when the first device does not exchange the content data, and to turn off power to the second wireless communication module when the first device exchanges the content data.

2. The wireless communication apparatus of claim 1, further comprising a command monitoring module configured to monitor the device control data in order to determine whether the device control data indicates a first or a second command,
wherein the power controller is configured to turn off power to the first wireless communication module when the device control data indicates the first command and to turn on power to the first device when the device control data indicates the second command.

3. The wireless communication apparatus of claim 2, wherein the first command comprises a command to stop operation of the first device, and the second command comprises a command to start operation of the first device.

4. A wireless communication method comprising:
exchanging content data and device control data with a first device, the first device performing communications with a second device for sending the content data;
causing a first wireless communication module to wirelessly exchanging the content data and the device control data with the second device when the first device exchanges the content data, wherein a first path for the content data is defined between the first wireless communication module and the interface module, the first wireless communication module consuming a first power;
causing a second wireless communication module to wirelessly exchanging exchange the device control data with the second device when the first device does not exchange the content data, the second wireless communication module consuming a second power that is lower than the first power;
setting a second path for the device control data between the interface module and the first wireless communication module, and causing the first wireless communication module to perform wireless communications for the device control data when the first device exchanges the content data;
setting a third path for the device control data between the interface module and the second wireless communication module and causing the second wireless communication module to perform wireless communications for the device control data, when the first device does not exchange the content data; and
turning off power to the first wireless communication module when the first device does not exchange the content data, and turning off power to the second wireless communication module when the first device exchanges the content data.
